(19) United States
(12) Patent Application Publication
(10) Pub. No.: US 2023/0368474 A1
(43) Pub. Date: Nov. 16, 2023

(54) LIGHTGUIDE-TYPE EYEPIECE FOR AUGMENTED REALITY HEADSETS WITH IMPROVED FIELD-OF-VIEW

(71) Applicant: AURORATECH COMPANY, San Francisco, CA (US)

(72) Inventors: Ziqi Peng, Burlingame, CA (US); Bayley Wang, Los Gatos, CA (US); Justin Krenz, Oakland, CA (US)

(73) Assignee: AURORATECH COMPANY, San Francisco, CA (US)

(21) Appl. No.: 18/123,438

(22) Filed: Mar. 20, 2023

Related U.S. Application Data
(60) Provisional application No. 63/321,685, filed on Mar. 19, 2022.

(51) Int. Cl. G06T 19/00; F21V 8/00; G02B 27/01

(52) U.S. Cl. CPC G06T 19/006; G02B 6/0055; G02B 27/0172

(57) ABSTRACT

Augmented reality headset (ARHS) eyepieces with a lightguide type ARHS eyepiece having one or more dimensions much thicker than one wavelength of visible light with one or more embedded reflectors. The lightguide eyepiece also incorporates, as part of its structure, one or more optically powered surfaces which are used to enhance the field-of-view of the ARHS.

### BACKGROUND

An augmented reality headset (ARHS) is a type of wearable display apparatus where the viewer is able to see both virtual, computer-generated images and the physical world. For this reason such devices are sometimes known as see-through head-mounted displays (HMDs).

One of the key components of an ARHS is the eyepiece, or combiner, the optical element which steers the light from the computer-generated images so that it is overlaid on top of the transmitted image from the physical world. In most embodiments, the combiner serves to act as a tilted, partially-reflecting mirror which deflects a portion of the light from the virtual image to the wearer's eye while also allowing a portion of the light from the physical world to be transmitted to the wearer's eye.

A number of technologies can be used to implement this tilted mirror. Some methods use a large, partially-silvered reflector, which can be flat or curved. Such a system is easy to design and fabricate, but suffers from geometric and ergonomic considerations which severely detract from its practical viability. Some systems use a series of flat and curved reflectors and lenses, allowing for a more compact form factor. However, realizing such a system requires multiple cascaded partial reflectors and polarization optics, which reduce the brightness of the transmitted, physical image to a point where the user experience is negatively affected. Yet other systems use a holographic element to reflect and focus light from a small projection engine mounted at the side of the wearer's head into the wearer's eye, but such a system exhibits a limited field of view (FOV). Another popular system uses a thin waveguide with a diffraction grating that redirects light to the wearer's eye, but the diffraction grating causes color dispersion of the transmitted image which prevents usage in bright conditions. Yet another system uses a thick waveguide, or lightguide, with dimensions much larger than the wavelength of visible light, and embedded out-coupling mirrors in the lightguide which reflect light into the viewer's eyes.

The present invention describes an advancement to the last system which improves the field of view supported by the lightguide while maintaining a compact size and high contrast ratio with no ghost or secondary images and maintaining high image uniformity. It is evident that improvements on the performance of such a lightguide eyepiece would facilitate its use and thereby advance the state of ARHS optical systems as a whole.

### SUMMARY

The present disclosure is related to augmented reality headset (ARHS) eyepieces, more precisely, a lightguide type ARHS eyepiece having one or more dimensions much thicker than one wavelength of visible light with one or more embedded reflectors. Present lightguide eyepiece also incorporates, as part of its structure, one or more optically powered surfaces which are used to enhance the field-of-view of the ARHS.

An exemplary embodiment includes an augmented reality display that has a monocular diagonal field of view of at least 60 degrees and an out-coupling element. The out-coupling element incudes a lightguide-type eyepiece with a sparse distribution of small mirrors and includes a light receiving input. The difference in intensity between a brightest point and a dimmest point of an image rendered on the augmented reality display is no more than five times.

In some embodiments, the lightguide-type eyepiece contains at least one reflective surface configured to collimate light from a projection system, whereby a real image is formed between 1 meter and infinity. Further, the light from the projection system entering the light receiving input of the lightguide-type eyepiece can be internally focused within the eyepiece.

Further, in some embodiments of the augmented reality display, positions, sizes, and shapes of the small mirrors in the distribution of small mirrors of the lightguide-type eyepiece, and parameters of the at least one reflective surface, are optimized with computer optimization software so as to not obscure light near the internal focus.

In some embodiments, the lightguide-type eyepiece contains a first lightguide and a second lightguide. In such embodiments, the first lightguide contains the sparse distribution of small mirrors, along with a coupling region which contains at least one optically powered surface. Light from the projection system enters the second lightguide containing no small mirrors and is substantially collimated by and transferred via the coupling region to the first lightguide.

Further, in some embodiments the coupling region inculdes but is not limited to, the end of the first lightguide, a surface that can be either cylindrical, a cylindrical, bi-cylindrical, and freeform, as well as the start of the second lightguide.

In some embodiments, the coupling region comprises the end of the first lightguide, two surfaces that are one of: cylindrical, a cylindrical, bi-cylindrical, and freeform. Further, these two surfaces are at an angle to guiding surfaces of the first and second lightguides and to each other, and the start of the second lightguide.

In some embodiments, the parameters of the coupling region are optimized to maximize coupling efficiency between the first and second lightguides. In some embodiments, the parameters of the small mirrors are optimized to improve the uniformity of the displayed image, taking into account the varying coupling efficiencies between the first and second lightguides across different points in the image.

### BRIEF DESCRIPTION OF THE DRAWINGS

FIG. 1 depicts an augmented reality headset (ARHS).

FIG. 2 depicts an embodiment of an ARHS optical system using a large partial reflector.

FIG. 3 depicts an embodiment of an ARHS optical system using a reflective/refractive system.

FIG. 4 depicts an embodiment of an ARHS optical system using a reflective hologram.

FIG. 5 depicts an embodiment of an ARHS optical system using a diffraction grating.

FIG. 6 depicts a lightguide.

FIG. 7 depicts an embodiment of an ARHS optical system using a lightguide eyepiece.

FIG. 8 depicts a lightguide eyepiece having sparse reflectors embedded within.

FIG. 9 depicts the path of light through a lightguide eyepiece.

FIG. 10 depicts the path of light through another lightguide eyepiece.

FIG. 11 depicts the one embodiment of a lightguide eyepiece.

FIG. 12 depicts the path of light from a single pixel (field) through a lightguide eyepiece.

FIG. 13 depicts a lightguide eyepiece having a wide field of view and high uniformity.

FIG. 14 depicts another lightguide eyepiece having a wide field of view and high uniformity.

FIG. 15 depicts a coupling region for a lightguide eyepiece.

FIG. 16 depicts another coupling region for a lightguide eyepiece.

FIG. 17 depicts a method of manufacturing a lightguide eyepiece having a wide field of view and high uniformity.

FIG. 18 depicts another method of manufacturing a lightguide eyepiece having a wide field of view and high uniformity.

### DETAILED DESCRIPTION OF EXEMPLARY EMBODIMENTS

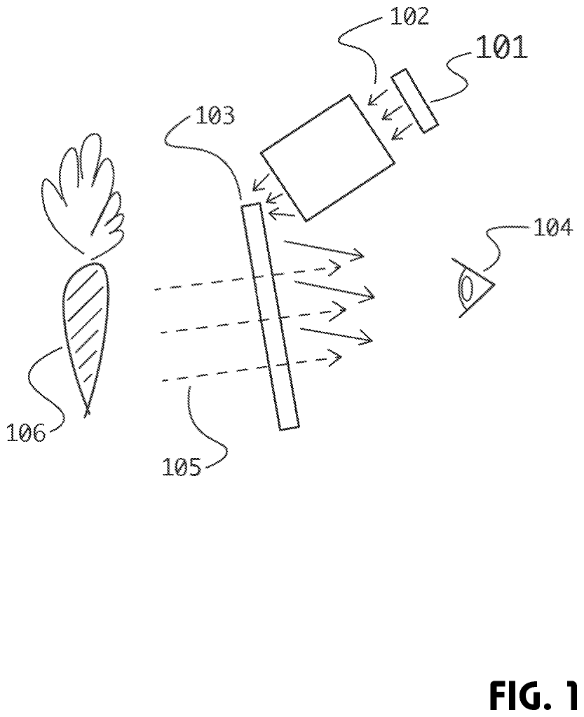

FIG. 1 depicts the optical path of an augmented reality headset (ARHS). A digital display 101 connected to a computing device displays a virtual image, the light 102 of which is transmitted through a projection module consisting of several (possibly zero) optical elements onto a eyepiece or combiner 103. The combiner redirects a portion of the light 102 into the wearer 104's eye, while also letting a portion of the light 105 from real objects 106 in the wearer's environment be transmitted to the wearer's eye. The overall effect is as if virtual images on the display generated by the computing device are placed in the wearer's environment.

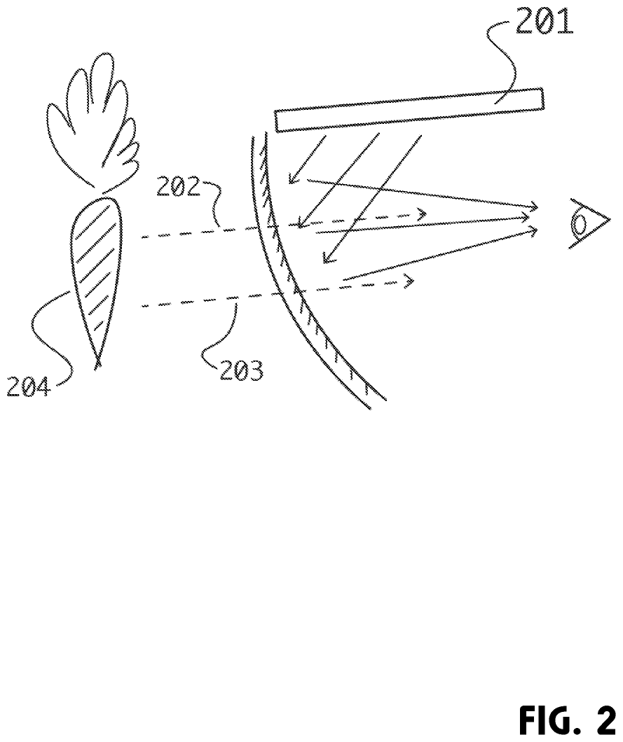

FIG. 2 depicts one embodiment of the eyepiece or combiner in which the light emitted by the display 201 is reflected from the curved, partially silvered reflector 202 to the wearer's eye. Either the front or back surface of the reflector is silvered, with the other being transparent, and the overall thickness and curvature of the two surfaces is such that the light 203 from objects 204 in the wearer's environment is transmitted undistorted to the wearer's eye.

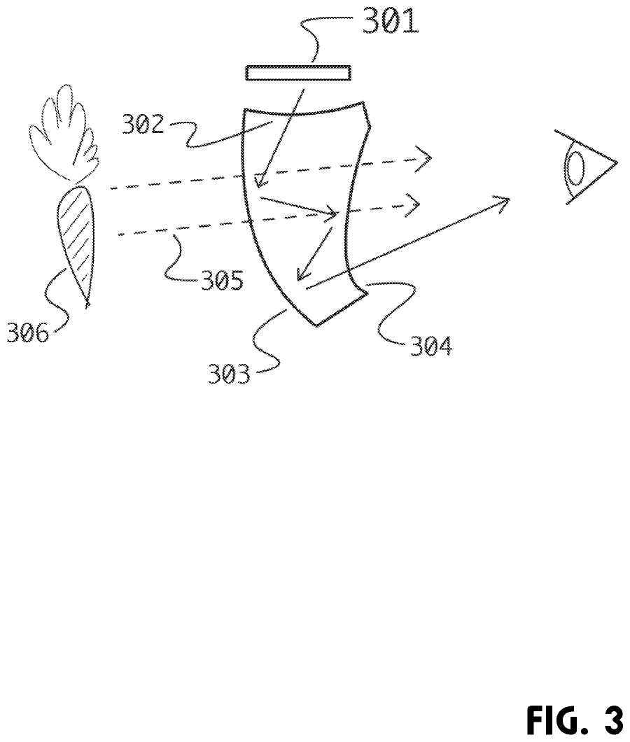

FIG. 3 depicts another embodiment of the eyepiece or combiner in which light emitted by the display 301 is reflected and refracted several times through a series of optically powered surfaces 302, 303, 304, which, in some embodiments, are the surfaces of one or more optical prisms placed in front of the wearer's eye. This system allows for the generation of a large field of view (FOV) by magnifying a smaller display while allowing light 305 from objects 306 in the wearer's environment to be transmitted undistorted to the wearer's eye.

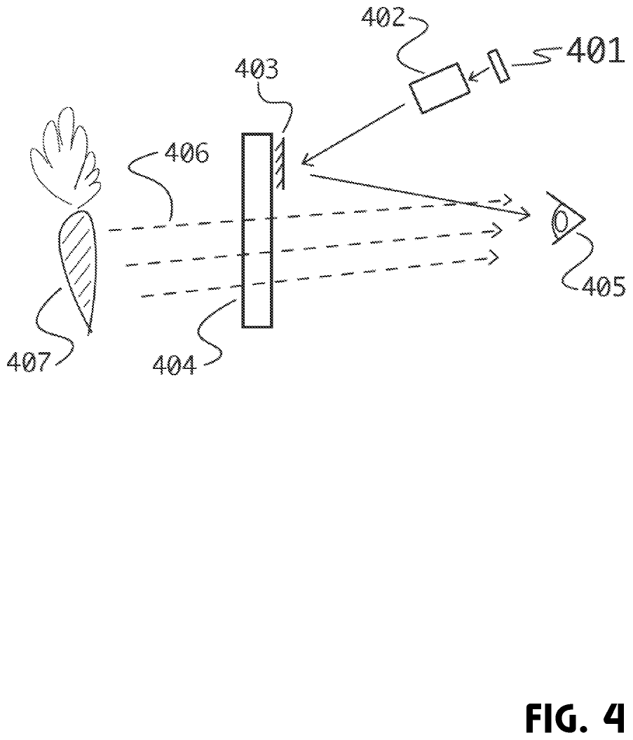

FIG. 4 depicts another embodiment of the eyepiece or combiner in which light emitted by the display 401, which in some embodiments is a temporally interlaced laser scanning system, is transmitted and/or reflected by a projection system 402 having zero or more elements before reflecting off of a hologram 403 on a eyewear lens 404 (which, in some embodiments is a prescription eyeglass lens). This hologram acts as a optically powered elements which redirects and focuses light to the wearer's eye 405; the mostly clear aperture of the eyewear lens allows light 406 from objects 407 in the wearer's environment to be transmitted undistorted to the wearer's eye.

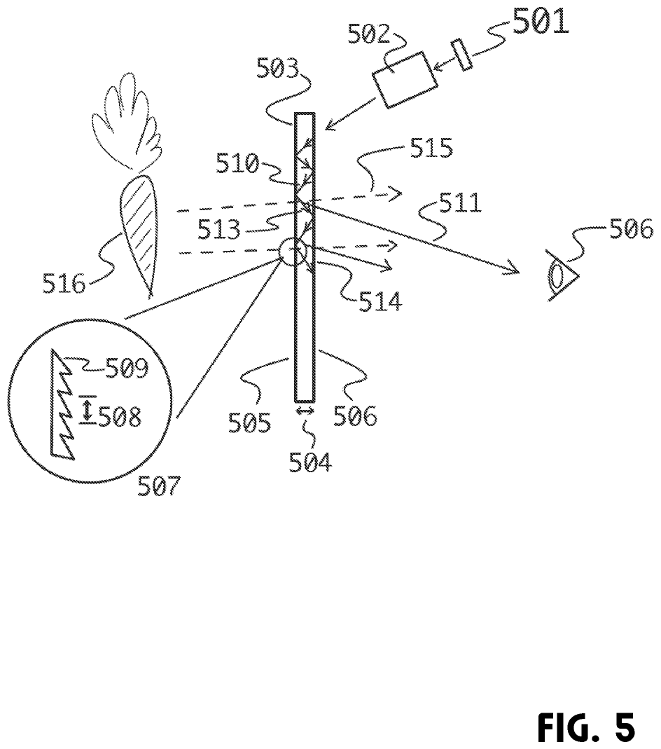

FIG. 5 depicts another embodiment of the eyepiece or combiner in which light 502 emitted by the display 501, which is some embodiments is a temporally interlaced laser scanning system and in some embodiments is a micro-projector utilizing a OLED, inorganic LED, liquid crystal, LCOS, or DMD microdisplay, is transmitted and/or reflected by a projection system having zero or more elements before being coupled into the thin waveguide 503 which has a thickness 504 comparable to one wavelength of visible light. The material of the waveguide has a higher refractive index than the surrounding air and therefore the light is confined to the propagation modes of this waveguide. One or both of the surfaces 505 and 506 of this waveguide has a nano-structured diffraction grating (detail 507) affixed to it. In some embodiments this grating is a blazed grating; in other embodiments it could be a complex metasurface. The pitch or spacing 508 of individual elements 509 of this grating is equal to or less than a wavelength of visible light. The interaction between the propagating light 510 and the diffraction grating redirects some of the light 511 in such a way that it leaks from the waveguide and enters the wearer's eye 512. Some of the propagating light 513 is redirected in a way that does not enter the viewer's eye; the remainder of the light 514 continues through the waveguide and is subsequently redirected by further interaction with the diffraction grating. Transmitted light 515 from objects 516 in the viewer's environment passes through the diffraction grating where based on the wavelength of the transmitted light, it gets diffracted at different angles.

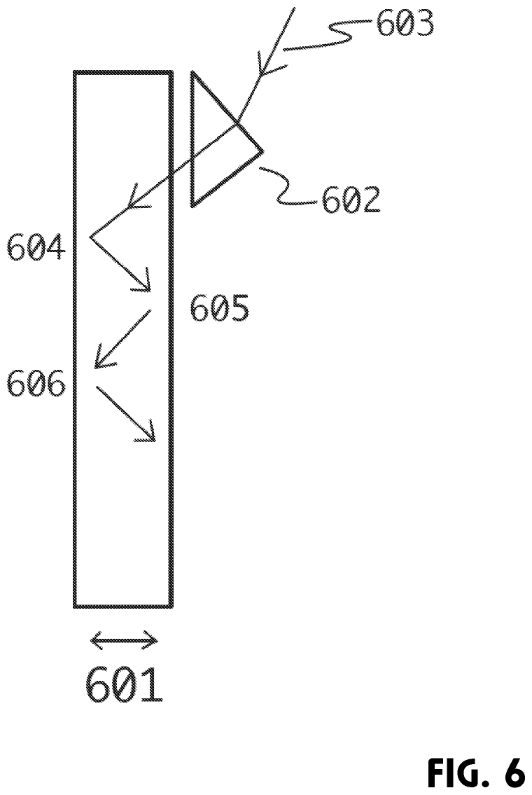

FIG. 6 depicts a lightguide. A lightguide is similar to a waveguide, with the exception that the dimensions 601 are all much larger than a wavelength of light; for example, 1 mm or more. A coupling element 602 injects light 603 into the body of the lightguide where it is confined by total internal reflection 604, 605, 606 and propagates inside the lightguide. The behavior of the lightguide can be analyzed in the geometric regime.

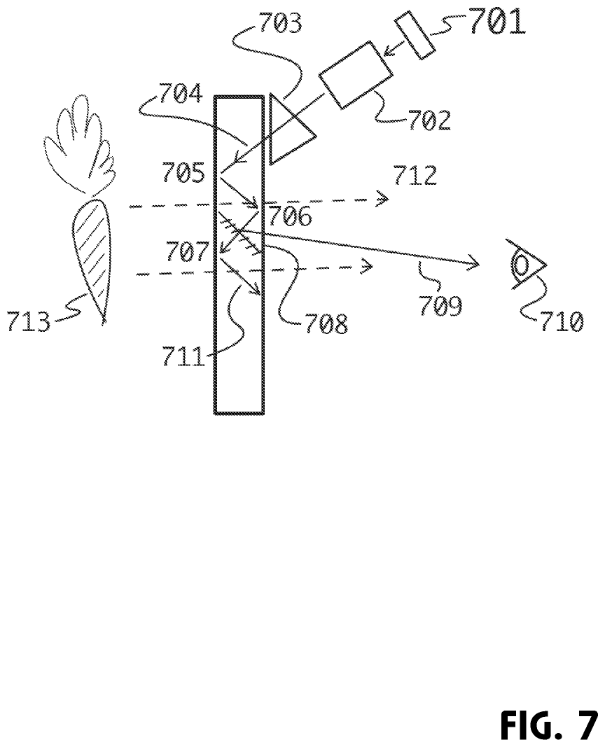

FIG. 7 depicts another embodiment of the eyepiece or combiner in which light emitted by the display 701 which is some embodiments is a temporally interlaced laser scanning system and in some embodiments is a micro-projector utilizing a OLED, inorganic LED, liquid crystal, LCOS, or DMD microdisplay, is transmitted and/or reflected by a projection system 702 having zero or more elements before entering the coupling element 703 which in some embodiments is a diffraction grating and in some embodiments is a refracting prism. The coupling element injects light 704 from the display into the lightguide where it is confined by total internal reflection 705, 706, 707. As the light propagates through the lightguide it encounters one or more slanted mirrors 708 which are arranged to allow a portion 709 of the propagating light to be redirected to the wearer's eye 710, and allows a portion 711 of the propagating light to continue to propagate through the lightguide. The slanted mirrors are also arranged in a way which allows transmitted light 712 from objects 713 in the wearer's environment to reach the viewer's eye.

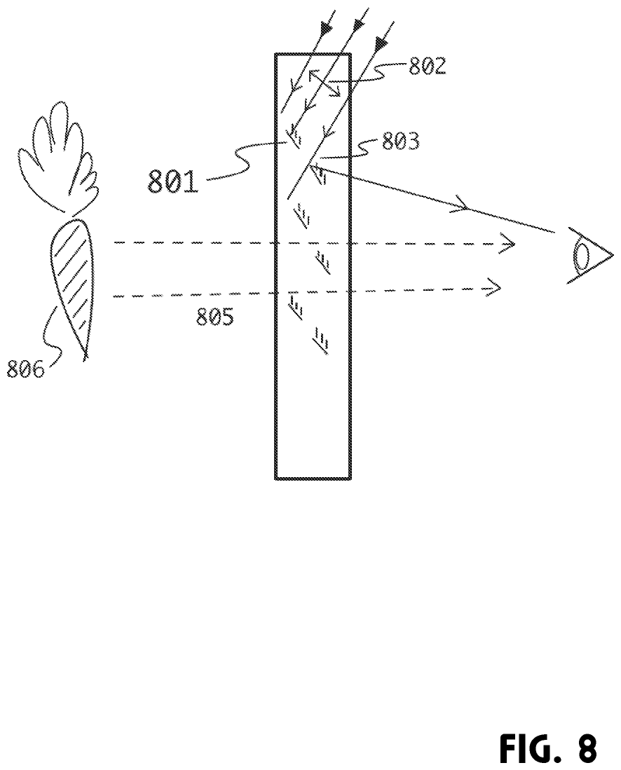

FIG. 8 depicts one embodiment of a lightguide eyepiece in which the slanted mirrors are arranged as a sparse distribution of small mirrors 801 with dimensions on the order of 1 mm such that the propagating beam of light 802 has dimension larger than that of the slanted mirror. In some embodiments, these mirrors are fully reflective mirrors across the operating wavelengths of the eyepiece. In other embodiments, these mirrors are a special coating, for example, but not limited to, a multi-band dielectric mirror, a holographic mirror, a polarization-sensitive coating, or a nano-structured coating. As the light propagates through the lightguide it encounters mirrors which redirect a small portion 803 of the light to the wearer's eye 804, while allowing the remaining portion of light to continue propagating. Similarly, light 805 from objects 806 in the wearer's environment is allowed to transmit through the gaps between the mirrors in an undistorted fashion.

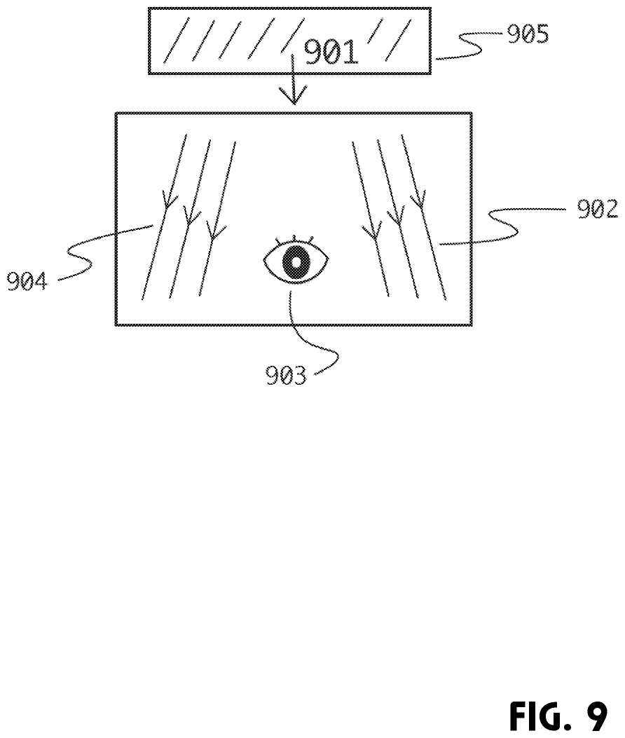

FIG. 9 depicts the path of light traveling through one possible configuration of the type of eyepiece depicted in FIG. 8. Light 901 is coupled into the eyepiece traveling downwards from the top of the eyepiece. It can be seen that light 902 corresponding to fields to the far right of the viewer's eye 903 must come from the far right of the eyepiece, and likewise light 904 from the far left of the viewer's eye must come from the far left of the eyepiece. This has an effect of increasing the size of the projection system 905 which transmits light into the eyepiece, as the horizontal size 906 of the projection system must span the entire width of the eyepiece, which can in some embodiments be over 50 mm.

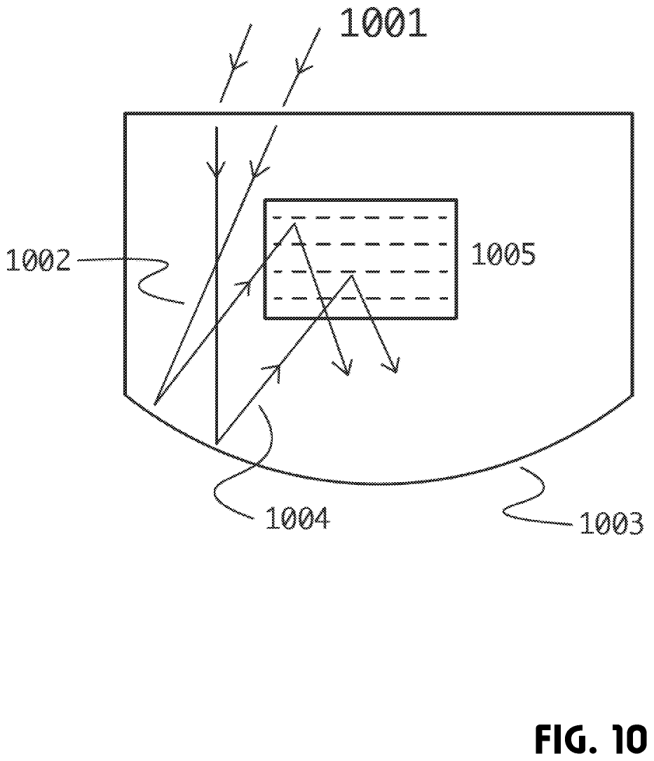

FIG. 10 depicts the path of light traveling through another possible configuration of the type of eyepiece depicted in FIG. 8. Light 1001 is coupled into the eyepiece such that it enters an internal focus 1002 before diverging and striking optically powered surface 1003, after which it further propagates through the eyepiece along path 1004 before being deflected out of the eyepiece by out coupling element(s) 1005. Internal focus 1002 need only be an approximate focus—the propagating light need not converge to a single point, and such a focus may only be in one direction. An internal focus is any volume in which the intensity of the light is sufficiently high, for example, but not limited to, a one cubic millimeter volume in which a significant portion, for example, more than one half, of the light from a single field which is coupled into the eyepiece is concentrated. The optically powered surface 1003 may be a cylindrical, toric, freeform, or aspheric surface, may have tilts and decenters, and may be a diffractive, refractive, reflective, Fresnel, kinoform, or metasurface, or any combination of these. The out coupling elements 1005 could be a sparse distribution of small mirrors, a diffraction grating, an array of slanted partially-reflecting mirrors, or any combination of these.

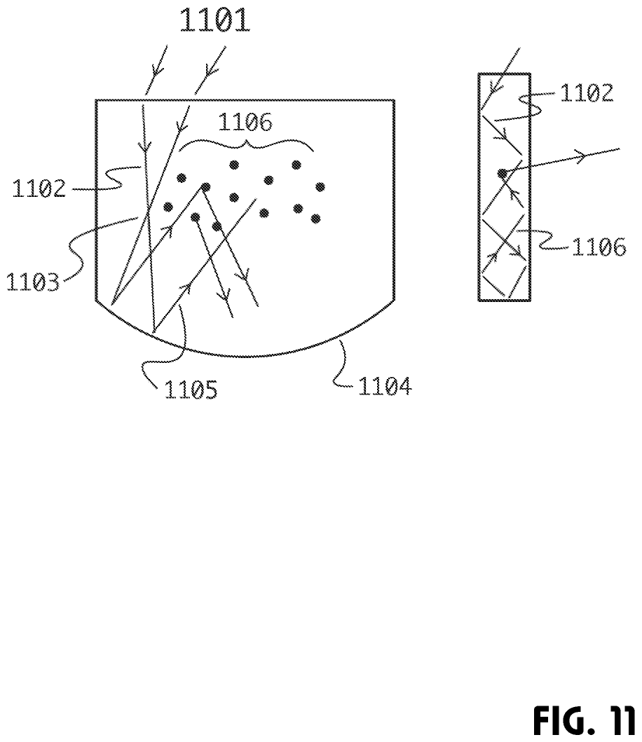

FIG. 11 depicts one possible embodiment of the eyepiece in FIG. 10. Light 1101 is coupled into the eyepiece on a path 1102 with an internal focus 1103 in one direction. After passing 1103 the light diverges until it strikes the concave collimating surface 1104, which in some embodiments need only to be a metasurface, Fresnel surface, diffractive surface, or hologram carrying the optical power of such a concave collimating surface and in some embodiments could be aspheric or freeform in one or both directions. After striking surface 1104 the light is collimated or nearly collimated so that the real image formed by the light lies at a distance between 1 meter and infinity from the lightguide. The light propagates through the lightguide on path 1105 whereupon it encounters a volume containing a sparse distribution of small mirrors which deflect light to the viewer's eye 1106. In some embodiments, the real image formed by the light after striking surface 1104 lies on a curved surface. What is important is that the image meets the standards for direct viewing systems in parameters such as contrast, MTF, astigmatism, and higher order aberrations, for example, in some embodiments the MTF of the system at 25 cycles per degree is at least 0.4 after accounting for field curvature.

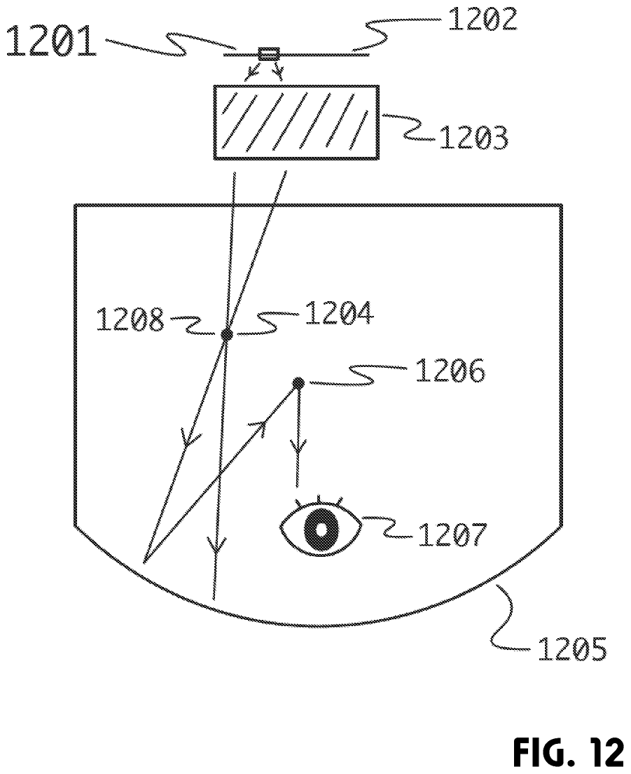

The apparatus depicted in FIG. 11 allows for a larger field of view in a smaller volume than the apparatus in FIG. 9 because it allows the projection system 1107 to be reduced in size, as no element of the projection system needs to be the width of the entire eyepiece. For example, a field of view of at least 60 degrees diagonal could be generated by a projection system where no element is wider than 30 mm. However, the particular embodiment in FIG. 11 could display reduced image uniformity. FIG. 12 depicts the light path of the light emitted by a particular pixel 1201 on the display 1202, which can be, but is not limited to, an OLED, DLP, LCOS, or micro-LED display which in some embodiments contains further devices which serve to replicate or expand the pixels on the physical display panel. In order to create collimated light, the projection system 1203 emits light which has a focus 1204 internal to the eyepiece. After passing the internal focus, which here is taken to mean any volume in which the intensity of the light is sufficiently high, for example, but not limited to, a one cubic millimeter volume in which a significant portion, for example, more than one half, of the light from a single field which is coupled into the eyepiece is concentrated, the light diverges before striking the collimating surface 1205, after which is continues to propagate in the reverse direction through the eyepiece before finally striking the small out-coupling mirrors 1206 and reaching the viewer's eye 1207. In this embodiment, if there are out-coupling mirrors 1208 situated within the volume of the internal focus, it is possible for an out-coupling mirror to significantly obscure the light emitted by pixel 1201. This can lead to significantly reduced efficiency, for example, zero efficiency in the case that the out-coupling mirrors 1208 entirely obscure the light emitted by pixel 1201, or significantly reduced uniformity, for example, when the light from pixel 1201 as viewed by the user has intensity at least five times lower than the mean value of the intensity of the pixels in the image.

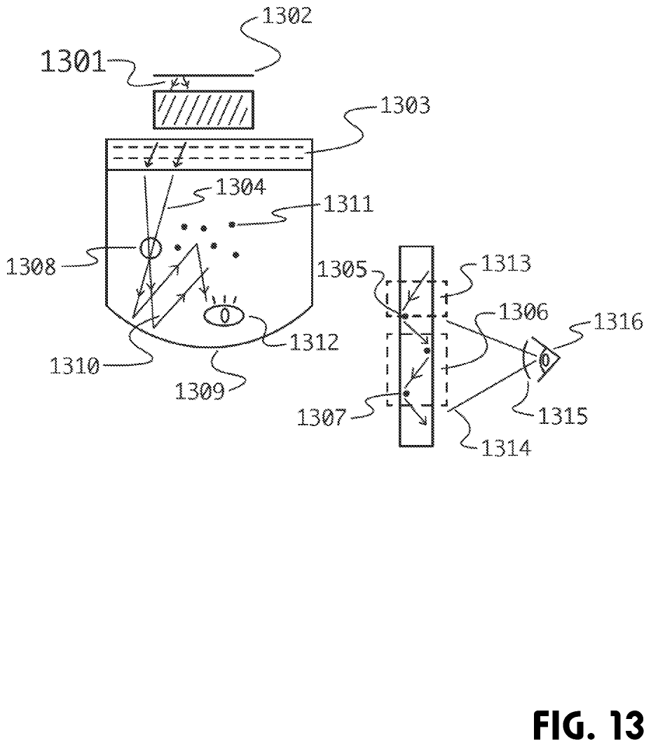

FIG. 13 depicts an embodiment of the eyepiece or combiner which is capable of achieving a large field-of-view using a sparse distribution of small mirrors as an out-coupling element while maintaining high efficiency and uniformity. Light 1301 emitted by the display 1302, which is some embodiments is a temporally interlaced laser scanning system and in some embodiments is a micro-projector utilizing a OLED, inorganic LED, liquid crystal, LCOS, or DMD microdisplay, is transmitted and/or reflected by a projection system having zero or more elements before entering the coupling element 1303 which in some embodiments is a diffraction grating and in some embodiments is a refracting prism. The coupling element injects light 1304 from the display into the lightguide where it is confined by total internal reflection 1305, 1306, 1307. After passing the internal focus 1308, which here is taken to mean any volume in which the intensity of the light is sufficiently high, for example, but not limited to, a one cubic millimeter volume in which a significant portion, for example, more than one half, of the light from a single field which is coupled into the eyepiece is concentrated, the light diverges before striking the collimating surface 1309, after which is continues to propagate by internal direction in the eyepiece along path 1310 before finally striking the small out-coupling mirrors 1311 and reaching the viewer's eye 1312. The totality of the points which are in the internal focuses of the various fields forms a volume 1313. The volume 1313 depends on the curvature and optical power of the collimating surface 1309. The volume 1314 containing the sparse distribution of small mirrors in the eyepiece is situated at a position depending on the field-of-view 1315 and the position of the viewer's eye 1316. By adjusting the relevant system parameters accordingly it is possible to move the volume 1313 so that it does not overlap with the volume 1314. It is possible to use an optimization software tool with the appropriate constraints and merit function in order to position the mirrors to maximize the efficiency and uniformity of the eyepiece while ensuring that the volumes 1313 and 1314 do not overlap. In this way, it is possible to achieve a large field-of-view, for example, but not limited to, a diagonal field-of-view of at least 60 degrees, using a projection system with compact elements, for example, but not limited to, a projection system where no element is wider than 30 mm.

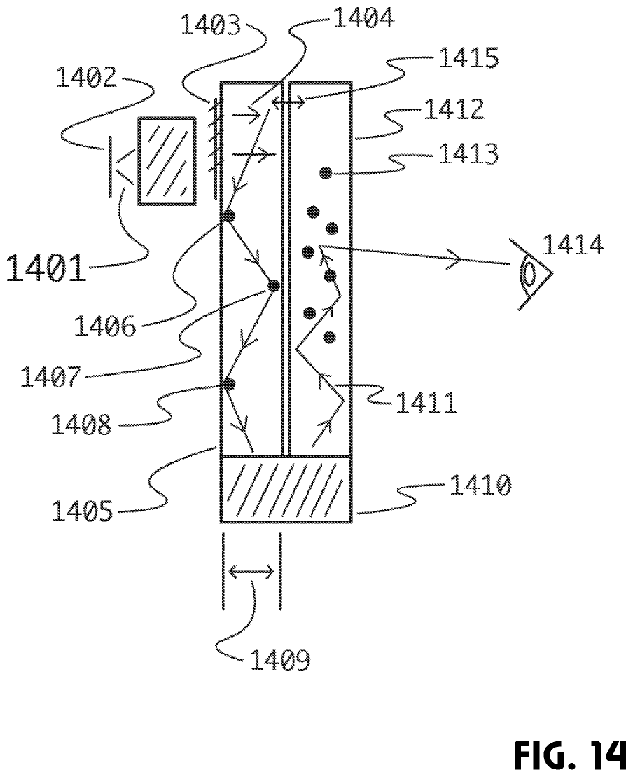

FIG. 14 depicts another embodiment of the eyepiece or combiner which is capable of achieving a large field-of-view using a sparse distribution of small mirrors as an out-coupling element while maintaining high efficiency and uniformity. Light 1401 emitted by the display 1402, which is some embodiments is a temporally interlaced laser scanning system and in some embodiments is a micro-projector utilizing a OLED, inorganic LED, liquid crystal, LCOS, or DMD microdisplay, is transmitted and/or reflected by a projection system having zero or more elements entering the coupling element 1403 which in some embodiments is a diffraction grating and in some embodiments is a refracting prism. The coupling element injects light 1404 from the display into the lightguide 1405 where it is confined by total internal reflection 1406, 1407, 1408. The lightguide 1405 is a bulk lightguide having dimension 1409 which is significantly larger than one wavelength of visible light. Light exits the lightguide 1405 and enters the coupling region 1410, which is an optically powered structure that may contain reflective, refractive, diffractive, freeform, kinoform, Fresnel, or metasurface surfaces such that the light exiting the coupling region 1411 is collimated or nearly collimated so that the real image formed by the light lies at a distance between 1 meter and infinity from the lightguide. In some embodiments, the real image so formed lies on a curved surface. What is important is that the image meets the standards for direct viewing systems in parameters such as contrast, MTF, astigmatism, and higher order aberrations, for example, in some embodiments the MTF of the system at 25 cycles per degree is at least 0.4 after accounting for field curvature. The light exiting the coupling region then enters lightguide 1412, which contains a sparse distribution of small mirrors 1413 which couple light into the viewer's eye 1414. The lightguides 1405 and 1412 are separated by a small space 1415.

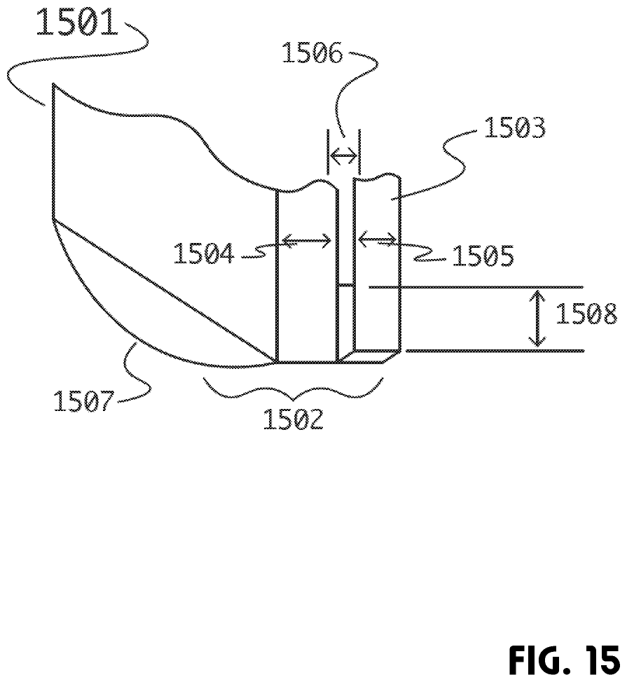

FIG. 15 depicts the detail of one possible design for the coupling region comprising of the end of the first lightguide 1501, the cylindrical area 1502, and the start of the second lightguide 1503. Lightguides 1501 and 1503 are parallel to each other and are separated by a small space. In some exemplary embodiments, the thicknesses 1504 and 1505 of the lightguides are between 1 and 5 millimeters and the thickness of the small space 1506 is between 20 micrometers and 300 micrometers. In some embodiments, the cylindrical surface 1507 is an acylindrical surface having a curvature which is aspheric or freeform, and in some embodiments, it is not necessarily perpendicular to the faces of the lightguides 1501 and 1504. The thickness 1504 and 1505, the height 1508 of the coupling region, and the radius or curvature of the cylindrical surface can be optimized to maximize coupling efficiency from lightguide 1501 to lightguide 1503. The positions, diameters, and shapes of the sparse distribution of small mirrors in lightguide 1502 can be optimized to further improve the uniformity and efficiency of the eyepiece. For example, the mirrors can be optimized to extract more light from fields with less coupling efficiency between the two lightguides, so as to make the final image seen by the viewer uniform.

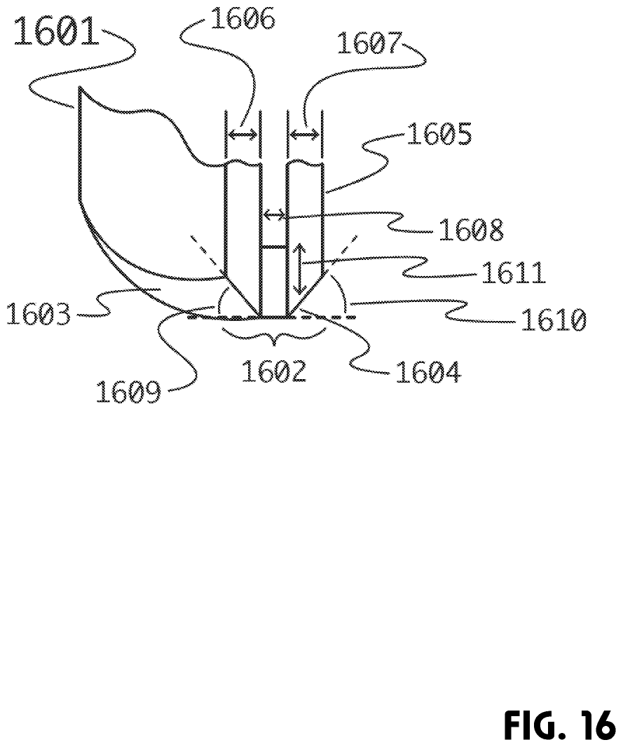

FIG. 16 depicts another design for the coupling region comprising of the end of the first lightguide 1601, the bi-cylindrical area 1602 with two cylindrical surfaces 1603 and 1604, and the start of the second lightguide 1605. Lightguides 1601 and 1605 are parallel to each other and are separated by a space. In some exemplary embodiments, the thicknesses 1606 and 1607 of the lightguides are between 1 and 5 millimeters and the spacing 1608 is between 20 micrometers and 1500 micrometers. In some embodiments, the angles 1609 and 1610 are between 30 and 45 degrees. In some embodiments, one or both of the surfaces 1603 and 1604 are acylindrical surface having a curvature which is aspheric or freeform. The angles 1609 and 1610, the thicknesses 1606 and 1607, the height 1611, and the spacing 1608 can be optimized to maximize coupling efficiency from lightguide 1601 to lightguide 1505. The positions, diameters, and shapes of the sparse distribution of small mirrors in lightguide 1605 can be optimized to further improve the uniformity and efficiency of the eyepiece. For example, the mirrors can be optimized to extract more light from fields with less coupling efficiency between the two lightguides, so as to make the final image seen by the viewer uniform.

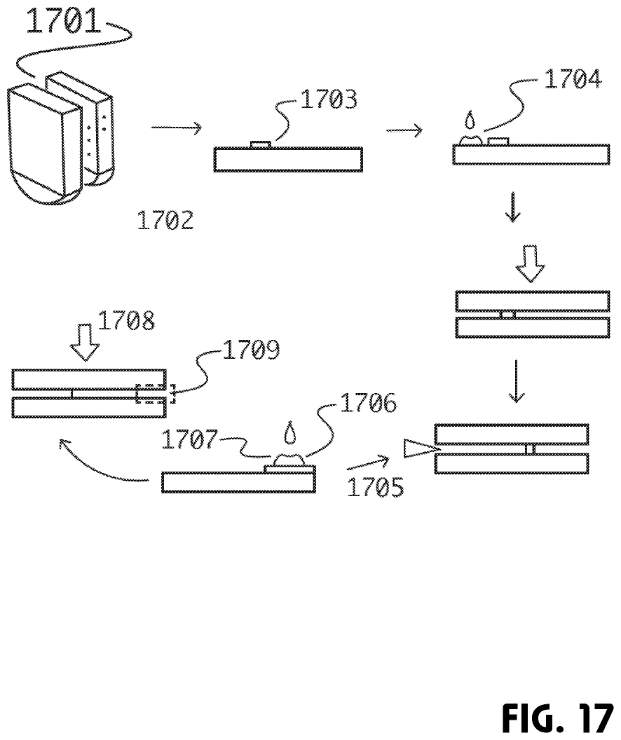

FIG. 17 depicts one method by which the apparatus in FIG. 15 may be manufactured. Light guides 1701 and 1702 are first manufactured using one of a number of manufacturing processes. For example, the light guide 1701 which does not have small mirrors inside could be manufactured using grinding, polishing, diamond turning, or injection molding, and the light guide 1702 could be manufactured as a laminated stack of coated layers. These methods are exemplary and do not encompass all of the possible ways to manufacture these light guides. A barrier 1703 having thickness equal to the desired spacing between the light guides is placed on one of 1701 or 1702. This barrier could be fabricated from adhesive tape having the desired total thickness. A quantity of transparent resin 1704 having the desired optical properties (for example, having index of refraction within 0.01 of the lightguide material) is deposited on one of the lightguides. The figure depicts this resin being deposited on the lightguide having the barrier on it, but it is understood this not need be the case. Lightguide 1701 is placed against lightguide 1702, and pressure is applied to compress and spread the resin. The resin is then cured, for example with UV light or by catalytic action. A force 1705 is applied to the gap between the two lightguides, for example with a blade or a wedge, to separate the two lightguides leaving a thin layer of resin 1706 on one of the lightguides. The barrier is then removed, then the same resin 1707 is deposited on 1706. The lightguides are aligned and a force 1708 is applied to compress and spread the resin. Finally, the resin is cured. In some other embodiments, stabilizing shims 1709 are used to ensure the two lightguides remain parallel to each other during the assembly process.

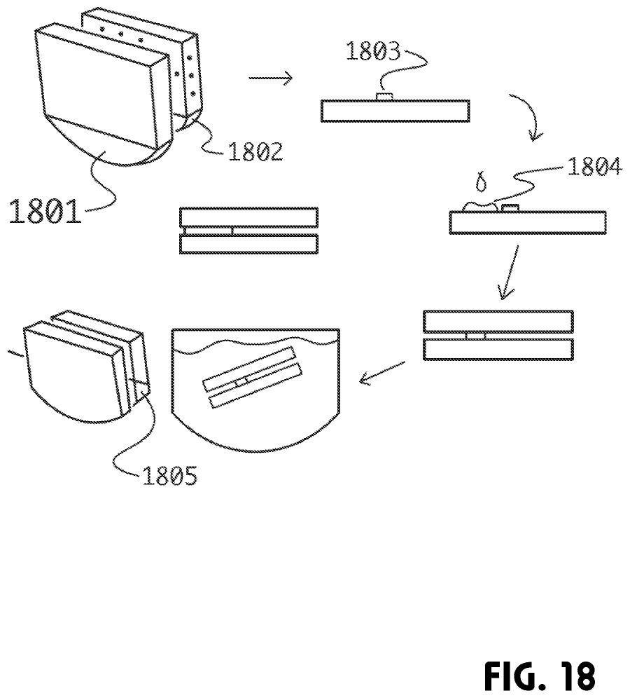

FIG. 18 depicts another method by which the apparatus in FIG. 15 may be manufactured. Light guides 1801 and 1802 are first manufactured using one of a number of manufacturing processes. For example, the light guide 1801 which does not have small mirrors inside could be manufactured using grinding, polishing, diamond turning, or injection molding, and the light guide 1802 could be manufactured as a laminated stack of coated layers. These methods are exemplary and do not encompass all of the possible ways to manufacture these light guides. A barrier 1803 having thickness equal to the desired spacing between the light guides is placed on lightguide 1801 or 1802. This barrier is fabricated from a material which is soluble in a solvent in which neither the lightguide material nor the subsequently deposited resin is substantially soluble in. For example, the barrier could be fabricated from an adhesive tape comprised of polyvinyl alcohol (PVA), which is soluble in water, and the lightguides and resin could be inorganic glass or acrylate polymer materials which are not substantially soluble in water. A quantity of transparent resin 1804 having the desired optical properties (for example, having index of refraction within 0.01 of the lightguide material) is deposited on one of the lightguides. The figure depicts this resin being deposited on the lightguide having the barrier on it, but it is understood this not need be the case. Lightguide 1801 is placed on lightguide 1802, and pressure is applied to compress and spread the resin. The resin is then cured, for example with UV light or by catalytic action. Subsequently, immersion in solvent is used to remove the barrier. In some embodiments, a thin wire or thread 1805 coated in solvent is used to aid the removal of the barrier. In some other embodiments, stabilizing shims 1806 are used to ensure the two lightguides remain parallel to each other during the assembly process.

The present invention has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons of the art.

It will be appreciated by persons skilled in the art that the present invention is not limited by what has been particularly shown and described herein above. Rather the scope of the invention is defined by the claims that follow.

What is claimed is:

1. An augmented reality display comprising:
a monocular diagonal field of view of at least 60 degrees;
an out-coupling element comprising:
a lightguide-type eyepiece with a sparse distribution of small mirrors and having a light receiving input, wherein a difference in intensity between a brightest point and a dimmest point of an image rendered on the augmented reality display is no more than five times.

2. The augmented reality display of claim 1, wherein the lightguide-type eyepiece contains at least one reflective surface configured to collimate light from a projection system, whereby a real image is formed between 1 meter and infinity.

3. The augmented reality display of claim 2, wherein light from the projection system entering the light receiving input of the lightguide-type eyepiece is internally focused within the eyepiece.

4. The augmented reality display of claim 3, wherein positions, sizes, and shapes of the small mirrors in the distribution of small mirrors of the lightguide-type eyepiece, and parameters of the at least one reflective surface, are optimized with computer optimization software so as to not obscure light near the internal focus.

5. The augmented reality display of claim 1, wherein the lightguide-type eyepiece contains a first lightguide and a second lightguide, the first lightguide containing the sparse distribution of small mirrors, along with a coupling region which contains at least one optically powered surface, wherein light from the projection system enters the second lightguide containing no small mirrors and is substantially collimated by and transferred via the coupling region to the first lightguide.

6. The augmented reality display of claim 5, wherein the coupling region comprises the end of the first lightguide, a surface that is one of: cylindrical; a cylindrical; bi-cylindrical; and freeform, and the start of the second lightguide.

7. The augmented reality display of claim 5, wherein the coupling region comprises the end of the first lightguide, two surfaces that are one of cylindrical, a cylindrical, bi-cylindrical, and freeform, which two surfaces are at an angle to guiding surfaces of the first and second lightguides and to each other, and the start of the second lightguide.

8. The augmented reality display of claim 5, wherein parameters of the coupling region are optimized to maximize coupling efficiency between the first and second lightguides.

9. The augmented reality display of claim 5, wherein parameters of the small mirrors are optimized to improve the uniformity of the displayed image, taking into account the varying coupling efficiencies between the first and second lightguides across different points in the image.

10. A method for manufacturing the augmented reality display of claim 6 wherein liquid resin with optical properties similar to bulk lightguide material and a barrier are used to form the coupling region, mechanical force is used to separate the first and second lightguides, the barrier is removed, then the first and second lightguides are glued to each other using the same resin.

11. A method for manufacturing the augmented reality display of claim 6 wherein a soluble barrier and liquid resin with optical properties similar to bulk lightguide material are used to form the coupling region, and a solvent which dissolves the barrier but neither the resin nor the bulk lightguide material is used to remove the barrier.
